(19) United States
(12) Patent Application Publication
(10) Pub. No.: US 2026/0054971 A1
(43) Pub. Date: Feb. 26, 2026

(54) Pallet Bumper Device

(71) Applicant: Henry Armstead, SR., Country Club Hills, IL (US)

(72) Inventor: Henry Armstead, SR., Country Club Hills, IL (US)

(21) Appl. No.: 19/097,171

(22) Filed: Apr. 1, 2025

Related U.S. Application Data
(60) Provisional application No. 63/684,891, filed on Aug. 20, 2024.

(51) Int. Cl. B66F 9/12

(52) U.S. Cl. CPC B66F 9/12

(57) ABSTRACT

A pallet bumper device is disclosed, which prevents the destruction of pallets or products while handling finished warehouse goods. The pallet bumper device comprises a lightweight and durable material that fills the void between forklift blades and deck boards before impact. The device essentially prevents damage to deck boards and products in warehouses and other areas where pallets and forklifts are commonly used. The device includes a body component having two gaps for accepting forklift tines. Further, the body component includes a middle bump stop and end bump stops which prevent the device from sliding off the tines.

### CROSS-REFERENCE TO RELATED APPLICATION

The present application claims priority to, and the benefit of, U.S. Provisional Application No. 63/684,891, which was filed on Aug. 20, 2024, and is incorporated herein by reference in its entirety.

### FIELD OF THE INVENTION

The present invention relates generally to the field of pallet bumper devices. More specifically, the present invention relates to a lightweight material that prevents the destruction of pallets in warehouses. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in pallet bumper devices. Generally, warehouses typically utilize forklifts to lift and transport items on wooden pallets. However, damage can occur to the wooden deck boards due to the forklift tines not being perfectly placed each time they lift a pallet. Further, products may need to be double handled due to the impact from a forklift. Thus, shifting of loads on pallets can occur and lead to spilled products and materials.

Further, items are commonly loaded and unloaded with fork trucks that extend tines or forks underneath the pallets loaded with goods. As the pallets are loaded or unloaded off of the trailer, the pallets can be damaged. This can result in damage to the products and materials on the pallets, as well.

Accordingly, there is a demand for an improved pallet bumper device that prevents the destruction of pallets in warehouses. More particularly, there is a demand for a pallet bumper device that fills the void between forklift blades/tines and deck boards prior to impact on the pallet.

Therefore, there exists a long felt need in the art for a pallet bumper device that provides users with a lightweight material that prevents the destruction of pallets in warehouses. There is also a long felt need in the art for a pallet bumper device that fills the void between forklift blades and deck boards prior to impact on the pallet. Further, there is a long felt need in the art for a pallet bumper device that saves considerable money on grade A pallets, preventing damage and reducing man hours needed to double handle products due to impacts from forklifts. Moreover, there is a long felt need in the art for a device that improves efficiency in manufacturing and shipping processes where forklifts and pallets are commonly used. Further, there is a long felt need in the art for a pallet bumper device that has a middle bump stop for preventing the device from sliding off the forklift tines. Finally, there is a long felt need in the art for a pallet bumper device that includes rubber spacers positioned behind the device to protect the forklift.

The subject matter disclosed and claimed herein, in one embodiment thereof, comprises a pallet bumper device. The device prevents the destruction of pallets or products while handling finished warehouse goods. The pallet bumper device comprises a lightweight and durable material that fills the void between forklift blades and deck boards before impact. The device essentially prevents damage to deck boards and products in warehouses and other areas where pallets and forklifts are commonly used. The device includes a body component having two gaps for accepting forklift tines. Further, the body component includes a middle bump stop and end bump stops which prevent the device from sliding off the tines. The body component includes rubber spacers positioned behind the body component to protect the forklift and tines.

In this manner, the pallet bumper device of the present invention accomplishes all of the forgoing objectives and provides users with a device that prevents the destruction of pallets in warehouses. The device fills the void between forklift blades and deck boards prior to impact on the pallet. The device is temperature rated.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pallet bumper device. The device includes a body component having two gaps for accepting forklift tines. Further, the body component includes a middle bump stop and end bump stops which prevent the device from sliding off the tines. The body component includes rubber spacers positioned behind the body component to protect the forklift and tines.

In one embodiment, the pallet bumper device prevents the destruction of pallets or products while handling finished warehouse goods. The pallet bumper device comprises a lightweight and durable material that fills the void between forklift blades and deck boards of a pallet before impact. The device essentially prevents damage to deck boards of the pallets and products in warehouses and other areas where pallets and forklifts are commonly used.

In one embodiment, the pallet bumper device comprises a body component. The body component is configured in an elongated rectangular shape or any suitable shape as is known in the art which comfortably fits over the tines of a forklift during use. Typically, the body component comprises a front surface, a rear surface, opposing side ends, a top surface, and a bottom surface. Generally, the body component is approximately 39 inches long, approximately 2-4 inches thick, and approximately 4 inches high (i.e., vertical) but can be any suitable shape and size as is known in the art, depending on the needs and/or wants of a user or depending on the size of the forklift used and/or the size of the pallet to be lifted, etc.

In one embodiment, the body component comprises two rectangular gaps for accepting forklift tines or blades. Typically, the gaps are spaced apart in a planar relationship, such that each accept a forklift tine or blade when the body component is resting on the forklift tines/blades. Further, each gap is approximately 5½ inches in length which allow for the side-to-side movement of the forklift blades/tines when the forklift blades/tines are to be adjusted to pick up a pallet. However, the gaps can be any suitable size as is known in the art depending on the adjustability of the forklift blades in a side-to-side or horizontal direction.

In one embodiment, the body component comprises wrap-around connection components positioned near the gaps. The wrap-around connection components can be any suitable connection component, such as a securing strap or a lip that secures the body component to the forklift tines. Specifically, the wrap-around connection components would be secured to a bottom surface of the body component and once the gaps accept the forklift tines and the body component is resting on the forklift tines, the wrap-around connection components are positioned around the forklift tines and secured. This secures the body component to the forklift for use.

In one embodiment, the body component includes a middle bump stop and a pair of end bump stops which prevent the body component from sliding off the tines. Specifically, the middle bump stop and the pair of end bump stops form the pair of gaps, which accept the forklift tines. The middle bump stop is an elongated rectangular shape and is positioned and secured to the bottom surface of the body component. The pair of end bump stops are rectangular in shape and are each positioned at and secured to opposing ends of the bottom surface of the body component.

In one embodiment, the body component includes rubber spacers positioned behind the body component to protect the forklift and tines. Specifically, there are approximately four spacers positioned behind the body component and secured to the rear surface of the body component. The spacers are approximately 2 inch×2 inch spacers. Further, the spacers are typically square or rectangular in shape but can be any suitable shape and size as is known in the art.

In one embodiment, the body component comprises a handle. Typically, the handle is approximately 3 inches in length. The handle can be any suitable shape and size as is known in the art. The handle can be any suitable handle as is known in the art. The handle can be secured to the top or bottom surface of the body component via any suitable securing means as is known in the art.

In operation, the pallet bumper device is positioned on the forklift tines, such that the body component rests on the forklift tines with the pair of gaps accepting the tines. Once in position, the wrap-around connection components are secured around each tine, securing the body component in place on the forklift tines. Then, the forklift and pallet bumper device can be utilized to lift pallets of materials and products in a conventional way without damaging the pallets.

In one embodiment, the pallet bumper device is manufactured from wood, rubber, silicone, fiber-reinforced plastic, etc., or other suitable temperature rated materials as is known in the art, or a combination of such materials and are cut from conventional lengths of such materials. Typically, the pallet bumper device is manufactured from a material that is temperature rated to −10 degrees but can be manufactured from a material that is temperature rated to any suitable temperature as is known in the art, depending on the needs and/or wants of a user. Further, the pallet bumper device is manufactured from a lightweight material to not add excess load strain on the hydraulics. Generally, the pallet bumper device is also manufactured from a material that is water resistant or waterproof, or the body component comprises a coating that is water resistant or waterproof.

In yet another embodiment, the pallet bumper device comprises a plurality of indicia.

In yet another embodiment, a method of protecting pallets during shipping processes where forklifts are used is disclosed. The method includes the steps of providing a pallet bumper device comprising a body component having two gaps for accepting forklift tines. The method also comprises positioning the body component on the forklift tines, such that the two gaps are positioned around the tines. Further, the method comprises securing a wrap-around connection component around the tines to secure the body component in place. The method also comprises utilizing the forklift to pick up a pallet of goods and materials. Finally, the method comprises protecting the pallet from damage during the shipping process via use of the pallet bumper device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one embodiment of the pallet bumper device of the present invention in accordance with the disclosed architecture;

FIG. 2 illustrates a perspective view of one embodiment of the pallet bumper device of the present invention showing the device applied to a forklift in accordance with the disclosed architecture;

FIG. 3 illustrates a top perspective view of one embodiment of the pallet bumper device of the present invention showing the device applied to a pallet in accordance with the disclosed architecture;

FIG. 4 illustrates a perspective view of one embodiment of the pallet bumper device of the present invention showing the device in use in accordance with the disclosed architecture;

FIG. 5 illustrates a perspective view of one embodiment of the pallet bumper device of the present invention showing the device and its components in accordance with the disclosed architecture; and

FIG. 6 illustrates a flowchart showing the method of protecting pallets during shipping processes where forklifts are used in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a pallet bumper device that provides users with a lightweight material that prevents the destruction of pallets in warehouses. There is also a long felt need in the art for a pallet bumper device that fills the void between forklift blades and deck boards prior to impact on the pallet. Further, there is a long felt need in the art for a pallet bumper device that saves considerable money on grade A pallets, preventing damage and reducing man hours needed to double handle products due to impacts from forklifts. Moreover, there is a long felt need in the art for a device that improves efficiency in manufacturing and shipping processes where forklifts and pallets are commonly used. Further, there is a long felt need in the art for a pallet bumper device that has a middle bump stop for preventing the device from sliding off the forklift tines. Finally, there is a long felt need in the art for a pallet bumper device that includes rubber spacers positioned behind the device to protect the forklift.

The present invention, in one exemplary embodiment, is a novel pallet bumper device. The pallet bumper device comprises a lightweight and durable material that fills the void between forklift blades and deck boards before impact. The device essentially prevents damage to deck boards and products in warehouses and other areas where pallets and forklifts are commonly used. The device includes a body component having two gaps for accepting forklift tines. The present invention also includes a novel method of protecting pallets during shipping processes where forklifts are used. The method includes the steps of providing a pallet bumper device comprising a body component having two gaps for accepting forklift tines. The method also comprises positioning the body component on the forklift tines, such that the two gaps are positioned around the tines. Further, the method comprises securing a wrap-around connection component around the tines to secure the body component in place. The method also comprises utilizing the forklift to pick up a pallet of goods and materials. Finally, the method comprises protecting the pallet from damage during the shipping process via use of the pallet bumper device.

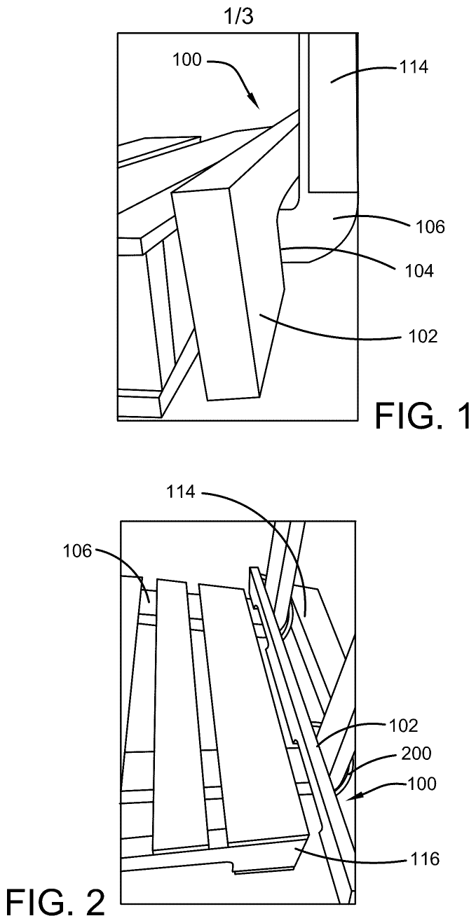

Referring initially to the drawings, FIG. 1 illustrates a perspective view of one embodiment of the pallet bumper device 100 of the present invention. In the present embodiment, the pallet bumper device 100 is an improved pallet bumper device 100 that prevents the destruction of pallets during the shipping process. Specifically, the pallet bumper device 100 comprises a body component 102 including a pair of gaps 104 sized to be positioned around forklift tines 106. Further, the body component 102 includes a middle bump stop 108 and end bump stops 110 which prevent the device 100 from sliding off the tines 106. The body component 102 includes rubber spacers 112 positioned behind the body component 102 to protect the forklift 114 and tines 106.

Generally, the pallet bumper device 100 prevents the destruction of pallets 116 or products while handling finished warehouse goods. The pallet bumper device 100 comprises a lightweight and durable material that fills the void between forklift blades 106 and deck boards of a pallet 116 before impact. The device 100 essentially prevents damage to deck boards of the pallets 116 and products in warehouses and other areas where pallets 116 and forklifts 114 are commonly used.

Further, the pallet bumper device 100 comprises a body component 102. The body component 102 is configured in an elongated rectangular shape or any suitable shape as is known in the art which comfortably fits over the tines 106 of a forklift 114 during use. Typically, the body component 102 comprises a front surface 118, a rear surface 120, opposing side ends 122, a top surface 124, and a bottom surface 126. Generally, the body component 102 is approximately 39 inches long, approximately 2-4 inches thick, and approximately 4 inches high (i.e., vertical) but can be any suitable shape and size as is known in the art, depending on the needs and/or wants of a user or depending on the size of the forklift 114 used and/or the size of the pallet 116 to be lifted, etc.

As shown in FIG. 2, the body component 102 comprises two rectangular gaps 104 for accepting forklift tines 106 or blades. Typically, the gaps 104 are spaced apart in a planar relationship, such that each accept a forklift tine 106 or blade when the body component 102 is resting on the forklift tines/blades 106. Further, each gap 104 is approximately 5½ inches in length which allow for the side-to-side movement of the forklift blades/tines 106 when the forklift blades/tines 106 are to be adjusted to pick up a pallet 116. However, the gaps 104 can be any suitable size as is known in the art depending on the adjustability of the forklift blades 106 in a side-to-side or horizontal direction.

Further, the body component 102 comprises wrap-around connection components 200 positioned near the gaps 104. The wrap-around connection components 200 can be any suitable connection component, such as a securing strap or a lip that secures the body component 102 to the forklift tines 106. Specifically, the wrap-around connection components 200 would be secured to a bottom surface 126 of the body component 102 and once the gaps 104 accept the forklift tines 106 and the body component 102 is resting on the forklift tines 106, the wrap-around connection components 200 are positioned around the forklift tines 106 and secured. This secures the body component 102 to the forklift 114 for use.

Additionally, the body component 102 includes a middle bump stop 108 and a pair of end bump stops 110 which prevent the body component 102 from sliding off the tines 106. Specifically, the middle bump stop 108 and the pair of end bump stops 110 form the pair of gaps 104, which accept the forklift tines 106. The middle bump stop 108 is an elongated rectangular shape and is positioned and secured to the bottom surface 126 of the body component 102. The pair of end bump stops 110 are rectangular in shape and are each positioned at and secured to opposing ends of the bottom surface 126 of the body component 102.

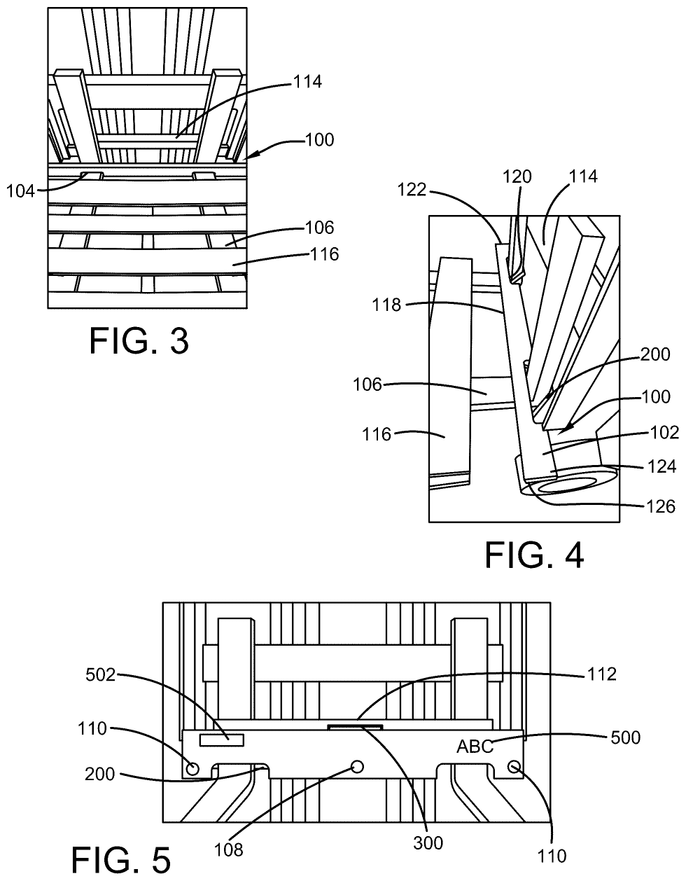

As shown in FIG. 3, the body component 102 includes rubber spacers 112 positioned behind the body component 102 to protect the forklift 114 and tines 106. Specifically, there are approximately four spacers 112 positioned behind the body component 102 and secured to the rear surface 120 of the body component 102. The spacers 112 are approximately 2 inch×2 inch spacers 112. Further, the spacers 112 are typically square or rectangular in shape but can be any suitable shape and size as is known in the art.

Further, the body component 102 comprises a handle 300. Typically, the handle 300 is approximately 3 inches in length. The handle 300 can be any suitable shape and size as is known in the art. The handle 300 can be any suitable handle as is known in the art, allowing a user to pick up the device and move it as needed. The handle 300 can be secured to the top 124 or bottom 126 surface of the body component 102 via any suitable securing means as is known in the art.

As shown in FIG. 4, in operation, the pallet bumper device 100 is positioned on the forklift tines 106, such that the body component 102 rests on the forklift tines 106 with the pair of gaps 104 accepting the tines 106. Once in position, the wrap-around connection components 200 are secured around each tine 106, securing the body component 102 in place on the forklift tines 106. Then, the forklift 114 and pallet bumper device 100 can be utilized to lift pallets 116 of materials and products in a conventional way without damaging the pallets 116.

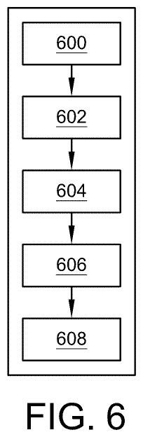

As shown in FIG. 5, the pallet bumper device 100 is manufactured from wood, rubber, silicone, fiber-reinforced plastic, etc., or other suitable temperature rated materials as is known in the art, or a combination of such materials and are cut from conventional lengths of such materials. Typically, the pallet bumper device 100 is manufactured from a material that is temperature rated to −10 degrees but can be manufactured from a material that is temperature rated to any suitable temperature as is known in the art, depending on the needs and/or wants of a user. Further, the pallet bumper device 100 is manufactured from a lightweight material to not add excess load strain on the hydraulics. Generally, the pallet bumper device 100 is also manufactured from a material that is water resistant or waterproof, or the body component 102 comprises a coating 502 that is water resistant or waterproof.

In yet another embodiment, the pallet bumper device 100 comprises a plurality of indicia 500. The body component 102 of the device 100 may include advertising, a trademark, or other letters, designs, or characters, printed, painted, stamped, or integrated into the body component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be pallet, forklift, or brand related.

FIG. 6 illustrates a flowchart of the method of protecting pallets during shipping processes where forklifts are used. The method includes the steps of at 600, providing a pallet bumper device comprising a body component having two gaps for accepting forklift tines. The method also comprises at 602, positioning the body component on the forklift tines, such that the two gaps are positioned around the tines. Further, the method comprises at 604, securing a wrap-around connection component around the tines to secure the body component in place. The method also comprises at 606, utilizing the forklift to pick up a pallet of goods and materials. Finally, the method comprises at 608, protecting the pallet from damage during the shipping process via use of the pallet bumper device.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pallet bumper device”, “bumper device”, “pallet device”, and “device” are interchangeable and refer to the pallet bumper device 100 of the present invention.

Notwithstanding the forgoing, the pallet bumper device 100 of the present invention can be of any suitable size and configuration as is known in the art without affecting the overall concept of the invention, provided that it accomplishes the above stated objectives. One of ordinary skill in the art will appreciate that the pallet bumper device 100 as shown in FIGS. 1-6 is for illustrative purposes only, and that many other sizes and shapes of the pallet bumper device 100 are well within the scope of the present disclosure. Although the dimensions of the pallet bumper device 100 are important design parameters for user convenience, the pallet bumper device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pallet bumper device that prevents the destruction of pallets during the shipping process, the pallet bumper device comprising:
a body component;
wherein the body component is positioned on a conventional forklift and forklift tines;
wherein the body component includes a pair of gaps sized to be positioned around a pair of forklift tines; and
further wherein the body component prevents damage to pallets in warehouses and other areas where pallets and forklifts are commonly used.

2. The pallet bumper device of claim 1, wherein the body component is configured in an elongated rectangular shape.

3. The pallet bumper device of claim 2, wherein the body component comprises a front surface, a rear surface, opposing side ends, a top surface, and a bottom surface.

4. The pallet bumper device of claim 3, wherein the body component is approximately 39 inches long, approximately 2-4 inches thick, and approximately 4 inches high.

5. The pallet bumper device of claim 4, wherein each of the pair of gaps is approximately 5½ inches in length which allow for side-to-side movement of the forklift tines when they need to be adjusted.

6. The pallet bumper device of claim 5, wherein the body component comprises wrap-around connection components positioned near the pair of gaps.

7. The pallet bumper device of claim 6, wherein the wrap-around connection components would be secured to a bottom surface of the body component and once the pair of gaps accept the forklift tines and the body component is resting on the forklift tines, the wrap-around connection components are positioned around the forklift tines and secured.

8. The pallet bumper device of claim 7, wherein the body component includes a middle bump stop secured to the bottom surface of the body component and a pair of end bump stops secured to opposing ends of the bottom surface, which both prevent the body component from sliding off the forklift tines.

9. The pallet bumper device of claim 8, wherein the middle bump stop and the pair of end bump stops form the pair of gaps, which accept the forklift tines.

10. The pallet bumper device of claim 9, wherein the body component includes rubber spacers positioned behind the body component to protect the forklift and the forklift tines.

11. The pallet bumper device of claim 10, wherein there are approximately four rubber spacers positioned behind the body component and secured to the rear surface of the body component.

12. The pallet bumper device of claim 11, wherein the rubber spacers are approximately 2 inch×2 inch spacers.

13. The pallet bumper device of claim 12, wherein the body component comprises a handle.

14. A pallet bumper device that prevents the destruction of pallets during the shipping process, the pallet bumper device comprising:
a body component configured in an elongated rectangular shape;
wherein the body component comprises a front surface, a rear surface, opposing side ends, a top surface, and a bottom surface;
wherein the body component is positioned on a conventional forklift and forklift tines;
wherein the body component includes a pair of gaps sized to be positioned around a pair of forklift tines;
wherein the body component comprises wrap-around connection components positioned near the pair of gaps;
wherein the body component includes a middle bump stop secured to the bottom surface of the body component and a pair of end bump stops secured to opposing ends of the bottom surface, which form the pair of gaps, which accept the forklift tines;
wherein the body component includes rubber spacers positioned behind the body component to protect the forklift and the forklift tines;
wherein the body component comprises a handle; and
further wherein the body component prevents damage to pallets in warehouses and other areas where pallets and forklifts are commonly used.

15. The pallet bumper device of claim 14, wherein the handle is approximately 3 inches in length.

16. The pallet bumper device of claim 15, wherein the handle can be secured to the top or bottom surface of the body component.

17. The pallet bumper device of claim 14, wherein the pallet bumper device is manufactured from a lightweight material, such as wood, rubber, silicone, or fiber-reinforced plastic, or other suitable materials temperature rated to −10 degrees.

18. The pallet bumper device of claim 17, wherein the pallet bumper device is also manufactured from a material that is water resistant or waterproof or comprises a coating that is water resistant or waterproof.

19. The pallet bumper device of claim 14 further comprising a plurality of indicia.

20. A method of protecting pallets during shipping processes where forklifts are used, the method comprising the following steps:
providing a pallet bumper device comprising a body component having two gaps for accepting forklift tines;
positioning the body component on the forklift tines, such that the two gaps are positioned around the tines;
securing a wrap-around connection component around the tines to secure the body component in place;
utilizing the forklift to pick up a pallet of goods and materials; and
protecting the pallet from damage during the shipping process via use of the pallet bumper device.
